(19) United States
(12) Patent Application Publication
(10) Pub. No.: US 2024/0062114 A1
(43) Pub. Date: Feb. 22, 2024

(54) MAPPING COASTAL ECOSYSTEMS

(71) Applicant: X Development LLC, Mountain View, CA (US)

(72) Inventors: Bertrand Louis Rene Delorme, San Francisco, CA (US); Alexandre Szenicer, London (GB); Antoni Jordi Ballester, San Francisco, CA (US); Bianca Bahman, San Francisco, CA (US); Julia Black Ling, Menlo Park, CA (US)

(21) Appl. No.: 18/452,044

(22) Filed: Aug. 18, 2023

Related U.S. Application Data
(60) Provisional application No. 63/399,068, filed on Aug. 18, 2022.

(51) Int. Cl. G06N 20/00; B64G 1/10; A01G 33/00

(52) U.S. Cl. CPC G06N 20/00; B64G 1/1021; A01G 33/00; G06Q 50/02

(57) ABSTRACT

Methods, systems, and apparatus, including computer programs encoded on computer storage media, for predicting features of an aquatic ecosystem. One of the methods includes generating, using ground truth data, first training input, wherein the first training input includes training labels; generating an augmented dataset from multiple data sources as second training input, wherein the augmented dataset is generated using (i) bathymetric data and (ii) simulated data based on satellite data indicating one or more coastal ecosystems; and training the machine learning model using (i) the first training input and (ii) second training input, such that the machine learning model is trained to predict biomass growth.

### CROSS-REFERENCE TO RELATED APPLICATION

This application claims the benefit of U.S. Provisional Application No. 63/399,068, filed Aug. 18, 2022, the contents of which are incorporated by reference herein.

### FIELD

This specification generally relates to applications of machine learning within an aquatic environment.

### BACKGROUND

Coastal ecosystems, such as seagrass, mangroves, and salt marshes, can serve as efficient carbon sequestration mechanisms, and can also play a role in flood resistance, erosion resistance, and local fishery productivity.

### SUMMARY

In some implementations, a system uses one or more of remote sensing data, in-water data, ocean simulation, or a combination that includes two or more of these, to predict suitability for sea plants of different species to grow. The system can map a current coverage of ecosystems (e.g., coastal ecosystems), where the ecosystems could be restored, and suitable locations after any impact of climate change or other environmental deteriorations. The system can also be used to predict carbon sequestration potential, flood or erosion resistance impact of restoration or conservation projects for ecosystems, among others.

Mapping coastal ecosystems, such as seagrass, mangroves, and salt marshes, is important for conservation and restoration. These ecosystems can serve as efficient carbon sequestration mechanisms, and can also play a role in flood resistance, erosion resistance, and local fishery productivity.

In general, one aspect of the subject matter described in this specification can be embodied in methods that include the actions of generating, using ground truth data, first training input, wherein the first training input includes training labels; generating an augmented dataset from multiple data sources as second training input, wherein the augmented dataset is generated using (i) bathymetric data and (ii) simulated data based on satellite data indicating one or more coastal ecosystems; and training the machine learning model using (i) the first training input and (ii) second training input, such that the machine learning model is trained to predict biomass growth.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, the machine learning model is trained to predict a likelihood of plant growth in a coastal region. In some implementations, the second training input includes an indication of one or more of temperature, chlorophyl, salinity, nutrients, or currents, and the actions include obtaining a likelihood that an area of a coastal region includes sea plants.

In some implementations, the actions include generating an indication of sea plant coverage within a coastal region as the output of the machine learning model processing the second training input. In some implementations, the machine learning model includes one or more of the following structures: a convolutional neural network, a random forest, a gradient boosted tree, or a Gaussian process. In some implementations, the machine learning model includes one or more of: kernel density estimation, one class support vector machines, or variational autoencoders. In some implementations, actions include providing the satellite data with one or more public datasets as input to the ocean simulation.

In some implementations, the ground truth data includes sensor data from one or more underwater sensors. In some implementations, the ground truth data includes an indication of sea plant coverage. In some implementations, the training labels indicate a presence of biomass.

The subject matter described in this specification can be implemented in various implementations and may result in one or more of the following advantages. For example, global warming threatens large swaths of animals and habitat around the world. One contributor of such global warming is an excess of carbon dioxide (CO₂). CO₂ can increase the absorption and emission of infrared radiation by the atmosphere, causing the observed rise in average global temperature and ocean acidification. Techniques described in this document can help efforts of carbon sequestration by predicting and identifying areas of seagrass growth or other carbon-based biomass that can be used for carbon storage to help reduce dissolved CO₂ in the atmosphere. Efforts for revitalizing or growing biomass can be focused on areas of high suitability, such as areas predicted to be high growth areas using the techniques described herein.

In some implementations, systems described in this document help combat climate change. For example, systems described in this document can predict biomass growth and map current biomass growth. By mapping seagrass and inferring a quantity of CO₂ stored, systems can unlock the possibility for countries or communities using their seagrass fields as carbon credit. Systems can help detect and quantify carbon capture. Typically, this process is infeasible and limited by manual observation techniques. Using techniques described in this document can increase efficiency and accuracy of predicting carbon capture and, generally, biomass growth incentivizing communities, e.g., through devices such as carbon credits, to preserve biomass, such as seagrass, which can be used as carbon credit. Without such techniques, quantification and therefore use of the biomass, such as sea grass for carbon credit can be difficult, impractical, or impossible. By determining locations and quantities of biomass, systems described can help reduce carbon emissions and restore ecosystems.

Systems described in this document can be used to help with ecosystem monitoring and preservation efforts, e.g., for individual species by tracking and forecasting which regions are suitable habitats. Predicting and estimating biomass can help develop economic activity for coastal communities, e.g., in developing countries. Systems described in this document can be used to help determine suitable or optimal locations for development, such as new coastal infrastructure, aquaculture farms, or renewable energy plants.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for predicting features of an aquatic ecosystem.

FIG. 2 is a diagram showing an example of a process for predicting features of an aquatic ecosystem.

FIG. 3 is a diagram showing an example of output indicating features of an aquatic ecosystem.

FIG. 4 is a flow diagram of an example process for training a model for prediction biomass

FIG. 5 is a diagram illustrating an example of a computing system used for predicting features of an aquatic ecosystem.

Like reference numbers and designations in the various drawings indicate like elements.

### DETAILED DESCRIPTION

Techniques described in this document help predict areas suitable for carbon sequestration—e.g., through the growing of sea grass, among other biomasses. These predictions can be used, e.g., to help address issues of climate change. Techniques use a combination of ocean simulation and trained machine learning models to provide accurate predictions indicating locations where growth can be achieved. Predictions can include both potential and current biomass predictions. Current biomass predictions may be beneficial in providing estimates over large regions or in regions where direct viewing—e.g., using autonomous submersible vehicles—is not feasible or is cost prohibitive. Predicting potential areas for growth may be beneficial in directing resources or conservation efforts which can help regions that are predicted to sustain biomass growth flourish.

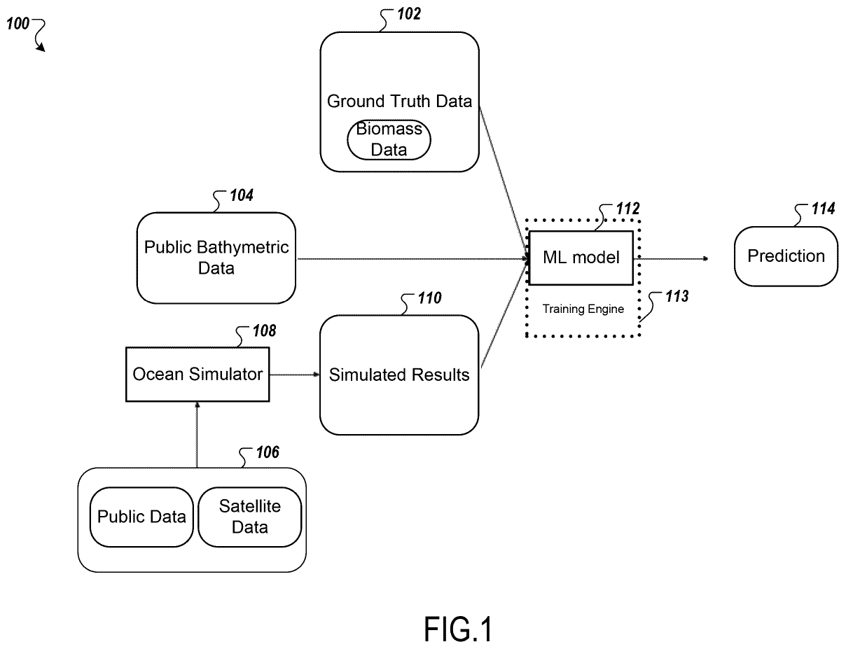

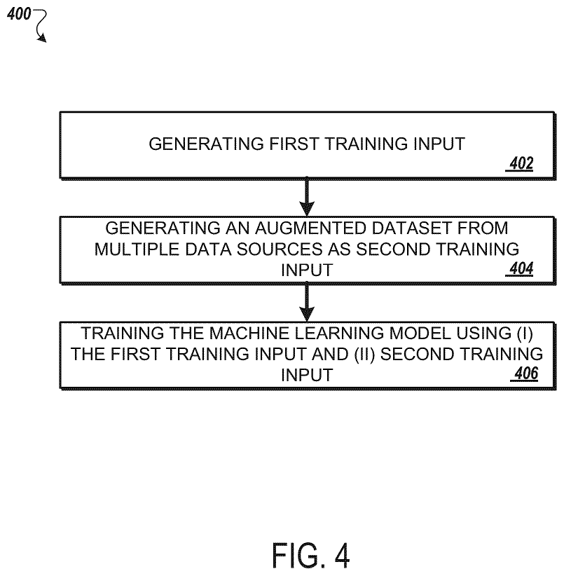

FIG. 1 is a diagram showing an example of a system 100 executing a process for predicting features of an aquatic ecosystem. The process may be performed by one or more electronic systems, for example, the computing device 400 or mobile computing device 450 of FIG. 4. For example, the training engine 113 or the ocean simulator 108 can be implemented using a computing device similar to the computing device 400 or the mobile computing device 450.

The system 100 includes providing data to a machine learning model 112. The data includes ground truth data 102. In some implementations, the ground truth data 102 includes one or more of known sea plant coverage, species, or biomass and carbon sequestration. This data can be generated by core sampling, quadrat-based estimation, surveys, aerial images or some combination of the above. This data can be included in the ground truth data 102. This data can be used by itself or be included with additional data. The data 102 can include underwater perception data, such as that provided by acoustic sensors, mono-camera or stereo-camera. The underwater perception data can be processed to predict a coverage, species, or biomass of underwater plants. Processed data can then be used as shown in FIG. 1 as training labels for the machine learning model 112 for training using the training engine 113.

The data provided to the machine learning model 112 can include bathymetric data 104. In some implementations, the bathymetric data 104 includes one or more values indicating a depth of a portion of an ocean, e.g., relative to sea level. In some implementations, the bathymetric data 104 includes one or more values indicating depths and shapes of underwater terrain. In some implementations, the system 100 includes providing the bathymetric data 104 to the machine learning model 112 to train, e.g., using the training engine 113, the machine learning model 112 to estimate a seafloor slope and a distance to coast. In some implementations, bathymetric data 104 can be supplemented with public datasets of major rivers, ports, or cities.

The data provided to the machine learning model 112 can include public data 106. In some implementations, the public data 106 includes a public dataset of ocean physics and biogeochemistry. The public dataset of ocean physics and biogeochemistry can be used as input to an ocean simulation 108. The public dataset can have coarse resolution or include few variables of interest. In some implementations, the public data 106 is supplemented by satellite data—e.g., from NASA or ESA satellite. Public data 106 can include data from one or more websites, such as Copernicus Marine Service. Public data 106 can include one or more public datasets.

The satellite data can be obtained from one or more satellites or processors that obtain information from one or more satellites. In some implementations, the satellite data is more informative than the public data 106. For example, ocean simulation on public data alone can be inaccurate. By supplementing with satellite data, ocean simulation accuracy can be improved.

The data provided to the machine learning model 112 can include data generated by the ocean simulation 108. In some implementations, the ocean simulation 108 is an ocean circulation model that solves partial differential equations for the conservation of mass and momentum of the ocean currents. In some implementations, the ocean simulation 108 is coupled to a wave height and/or biogeochemical models. The ocean simulation 108 can have its hyper parameters tuned (e.g., by a processing computer or mobile computer device similar to that shown in FIG. 4) to local data using Bayesian optimization to improve the ocean simulation accuracy. For example, the local mixing coefficients can be tuned using local data for temperature, salinity, or dissolved oxygen. The ocean simulation 108 can be used to predict simulation results 110.

The data provided to the machine learning model 112 can include simulation results 110. In some implementations, the simulation results 110 include one or more values, e.g., dissolved oxygen, ocean currents, ocean kinetic energy, temperature, and dissolved nutrients, among others. Values of the simulation results 110 can be predicted on a three-dimensional (3D) grid over a region of interest. In some implementations, one or more values of the simulation results 110 represent the same elements of a system as one or more values of the public data 106. The one or more values of the simulation results 110 can be more accurate and operate at a higher spatial resolution than the public data 106.

In some implementations, the ocean simulation 108 generates new variables or potential features that are not available through public datasets. Such new variables or potential features can include ocean mixing or eddy kinetic energy, among others.

In some implementations, the bathymetric data 104 and the simulation results 110 are combined as inputs to the machine learning model 112. The ground truth data 102 can be used as the training labels for training the machine learning model 112—e.g., by the training engine 113—on the bathymetric data 104 and the simulation results 110. In some implementations, the machine learning model 112 includes one or more of the following structures: a convolutional neural network, a random forest, a gradient boosted tree, a Gaussian process, or any other regression or classification algorithm. In some implementations, the machine learning model 112 is a density estimation approach (such as kernel density estimation, one class support vector machines, variational autoencoders).

The machine learning model 112 generates predictions 114. In some implementations, the predictions 114 include one or more of sea plant coverage, sparsity, or species. In some implementations, the predictions 114 include an indication of whether or not an area has seagrass or how much biomass, e.g., of seagrass, is stored in the area.

The machine learning model 112 can predict the suitability of a habitat for a given sea plant, e.g., for purposes of restoration. The machine learning model 112 can predict an amount of carbon sequestered, such as a current amount of carbon sequestered, or the carbon sequestration potential if one or more sea plants or aspects of the ecosystem were restored. The predictions 114 can be categorical (e.g., seagrass or no seagrass), real valued (e.g., seagrass biomass per meter squared) or probabilistic (e.g., probability distribution of seagrass biomass per meter squared), among others. The predictions 114 could include predictions of flood resistance, forecasted impact of flood, or erosion forecasts.

In some implementations, the system, including the machine learning model 112, is run using modified boundary and initial conditions. The modified boundary and initial conditions can be based on future climate predictions. The machine learning model 112 can generate predictions as described under conditions of climate change. For example, it could be of interest to assess the suitability of a given coastal region for seagrass meadows now and in the future when the water temperature is 1 degree warmer. Other ecological, social, and regulatory inputs could also be included to evaluate their effect on seagrass restoration and carbon sequestration.

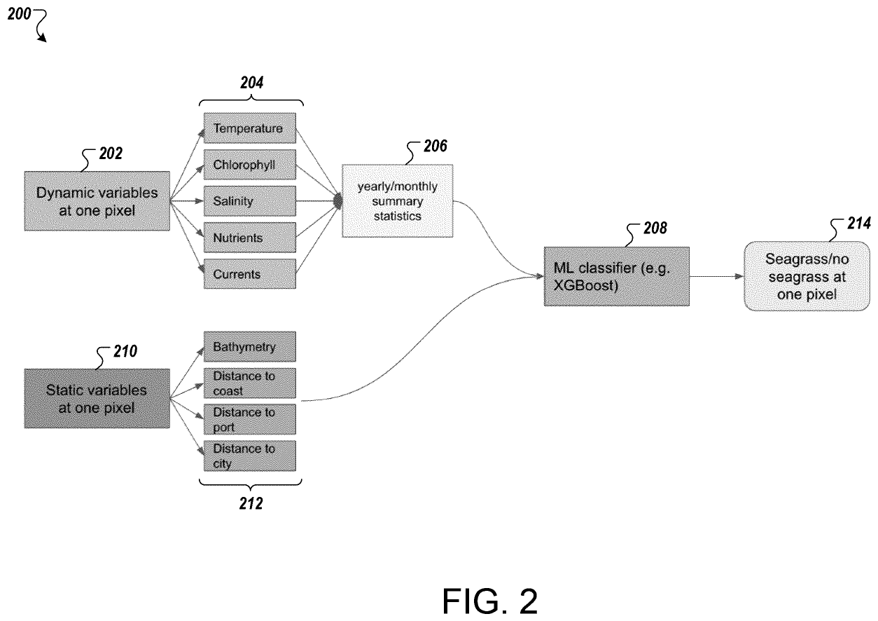

FIG. 2 is a diagram showing an example of a process 200 for predicting features of an aquatic ecosystem. The process 200 may be performed by one or more electronic systems, for example, the computing device 400 or mobile computing device 450 of FIG. 4.

The process 200 shows a version of the system 100. For example, dynamic variables 202 (including variables 204 shown in FIG. 2) and static variables 210 (including variables 212 shown in FIG. 2) can be provided to a machine learning classifier 208. The machine learning classifier 208 can generate seagrass data 214, e.g., in a given area or pixel.

In some implementations, variables are combined to generate data items for input to the machine learning classifier 208. For example, the variables 204, shown in FIG. 2, can be combined to generate statistics 206. The statistics 206 can be provided (e.g., by a processing element, for example, the computing device 400 or mobile computing device 450 of FIG. 4) to the machine learning classifier 208.

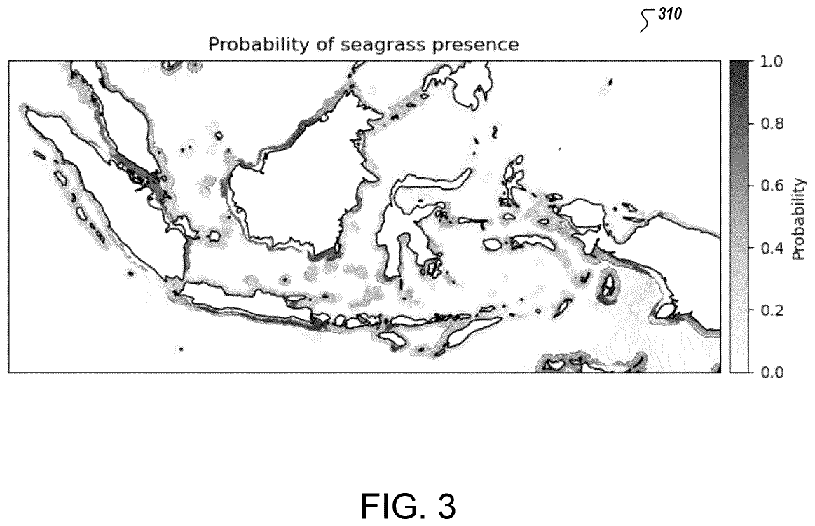

FIG. 3 is a diagram showing an example of output 310 indicating features of an aquatic ecosystem. The output 310 can be included in the predictions 114 generated in the system 100. In some implementations, the output 310 provides an indication of a likelihood that a given area includes a particular aquatic feature. For example, the output 310 can provide an indication of a likelihood that a given area includes sea grass or an amount of sea grass. The output 310 can include a heat map indicating areas that have a higher likelihood of including a particular aquatic feature compared to other areas. In some implementations, the output 310 is provided to a user or provided to a system (e.g., with one or more automated elements) to perform one or more automated processes.

In some implementations, automated processes include one or more comparisons. For example, automated processes can include validation or comparison with ground truth, satellite data, or other mapping system. Data for comparison or validation can be linked to geospatial data, such as land ownerships, among others. In some implementations, automated processes include training steps. For example, a system, such as the system 100, can be used for training a machine learning model. The model can identify which areas do not generate a clear signal regarding a prediction of current or predictive biomass growth. The model can identify such areas for further data retrieval—e.g., using a signal to instruct a submersible camera device or other autonomous or semi-autonomous sensor to collect data within the areas. Using the sensor data, the system, such as the system 100, can train the model—e.g., using data indicative of the sensor data as ground truth data.

In some implementations, a system is used to automate the deployment of physical monitoring systems. For example, the system 100 can be used to automate the deployment of remote operated vehicles (ROVs), drones, among others. The system 100 can configure signals to control the physical monitoring systems to take detailed measurements in regions identified by the system—e.g., for which a prediction error likelihood satisfies a threshold, confidence threshold satisfies a threshold, among others.

In some implementations, a system automates deployment of ecosystem conservation and restoration approaches. For example, the system 100 can be used to automate one or more devices configured to plant seeds in a region predicted by the system 100 to be conducive for biomass growth, where the seeds to be planted are selected to match a biomass predicted to grow well in the area. In some implementations, the system determines other species that can help biodiversity of ecosystem health. For example, the system 100 can determine one or more species that have a symbiotic relationship and generate one or more signals to devices configured to place species with other species for mutual benefit.

FIG. 4 is a flow diagram of an example process 400 for training a model for prediction biomass. For example, the process 400 can be used by the system 100 from FIG. 1.

The process 400 includes generating first training input (402). For example, the system 100 can generate the data 102. In some implementations, the ground truth data 102 includes one or more of known sea plant coverage, species, or biomass and carbon sequestration. This data can be generated by core sampling, quadrat-based estimation, surveys, aerial images or some combination of the above.

The process 400 includes generating an augmented dataset from multiple data sources as second training input (404). For example, the system 100 can obtain or generate the bathymetric data 104 which can include one or more values indicating a depth of a portion of an ocean, e.g., relative to sea level. The augmented dataset can include bathymetric data and satellite data.

The process 400 includes training the machine learning model using (i) the first training input and (ii) second training input (406). For example, the ground truth data 102 can be used as the training labels for training the machine learning model 112—e.g., by the training engine 113—on the bathymetric data 104, the simulation results 110, among others.

The order of operations in the process 400 described above is illustrative only and can be performed in different orders. In some implementations, the process 400 can include additional operations, fewer operations, or some of the operations can be divided into multiple operations.

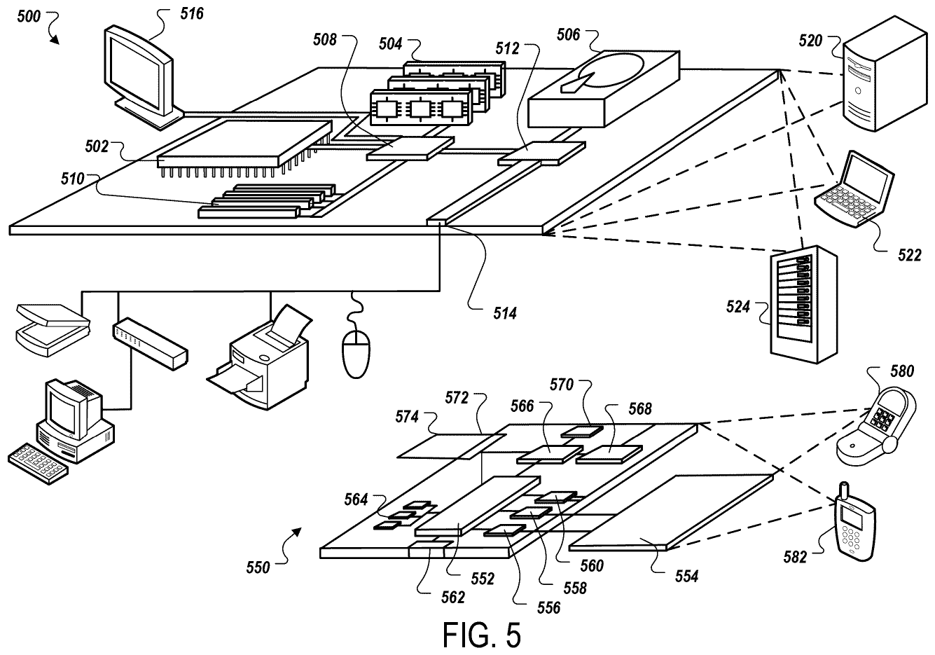

FIG. 5 is a diagram illustrating an example of a computing system used for predicting features of an aquatic ecosystem. The computing system includes computing device 500 and a mobile computing device 550 that can be used to implement the techniques described herein. For example, the process described in FIG. 1 with the system 100 or the process 200 can be performed by one or more instances of the computing device 500 or the mobile computing device 550.

In some implementations, the computing device 500 or the mobile computing device 550 implement the machine learning model 112, devices that access information from the machine learning model 112, or a server that accesses or stores information regarding the operations performed by the machine learning model 112.

The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 502 is a single threaded processor. In some implementations, the processor 502 is a multi-threaded processor. In some implementations, the processor 502 is a quantum computer.

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502). The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device, such as a mobile computing device 550. Each of such devices may include one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may include appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (nonvolatile random-access memory), as discussed below. In some implementations, instructions are stored in an information carrier such that the instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry in some cases. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 568 using a radio frequency. In addition, short-range communication may occur, such as using a Bluetooth, Wi-Fi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, among others) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A system for training a machine learning model, the system comprising one or more computers and one or more storage devices on which are stored instructions that are operable, when executed by the one or more computers, to cause the one or more computers to perform operations comprising:
generating, using ground truth data, first training input, wherein the first training input includes training labels;
generating an augmented dataset from multiple data sources as second training input, wherein the augmented dataset is generated using (i) bathymetric data and (ii) simulated data based on satellite data indicating one or more coastal ecosystems; and
training the machine learning model using (i) the first training input and (ii) the second training input, such that the machine learning model is trained to predict biomass growth.

2. The system of claim 1, wherein the machine learning model is trained to predict a likelihood of plant growth in a coastal region.

3. The system of claim 1, wherein the second training input includes an indication of one or more of temperature, chlorophyl, salinity, nutrients, or currents, and the operations comprise:
obtaining a likelihood that an area of a coastal region includes sea plants.

4. The system of claim 1, wherein the operations comprise:
generating an indication of sea plant coverage within a coastal region as output of the machine learning model processing the second training input.

5. The system of claim 1, wherein the machine learning model includes one or more of the following structures: a convolutional neural network, a random forest, a gradient boosted tree, or a Gaussian process.

6. The system of claim 1, wherein the machine learning model includes one or more of: kernel density estimation, one class support vector machines, or variational autoencoders.

7. The system of claim 1, wherein the operations comprise:
providing the satellite data with one or more public datasets as input to an ocean simulation.

8. The system of claim 1, wherein the ground truth data includes sensor data from one or more underwater sensors.

9. The system of claim 1, wherein the ground truth data includes an indication of sea plant coverage.

10. The system of claim 1, wherein the training labels indicate a presence of biomass.

11. A method comprising:
generating, using ground truth data, first training input, wherein the first training input includes training labels;
generating an augmented dataset from multiple data sources as second training input, wherein the augmented dataset is generated using (i) bathymetric data and (ii) simulated data based on satellite data indicating one or more coastal ecosystems; and
training a machine learning model using (i) the first training input and (ii) the second training input, such that the machine learning model is trained to predict biomass growth.

12. The method of claim 11, wherein the machine learning model is trained to predict a likelihood of plant growth in a coastal region.

13. The method of claim 11, wherein the second training input includes an indication of one or more of temperature, chlorophyl, salinity, nutrients, or currents, and the operations comprise:
obtaining a likelihood that an area of a coastal region includes sea plants.

14. The method of claim 11, comprising:
generating an indication of sea plant coverage within a coastal region as output of the machine learning model processing the second training input.

15. The method of claim 11, wherein the machine learning model includes one or more of the following structures: a convolutional neural network, a random forest, a gradient boosted tree, or a Gaussian process.

16. The method of claim 11, wherein the machine learning model includes one or more of: kernel density estimation, one class support vector machines, or variational autoencoders.

17. The method of claim 11, comprising:
providing the satellite data with one or more public datasets as input to an ocean simulation.

18. The method of claim 11, wherein the ground truth data includes sensor data from one or more underwater sensors.

19. The method of claim 11, wherein the ground truth data includes an indication of sea plant coverage.

20. One or more non-transitory computer storage media encoded with instructions that, when executed by one or more computers, cause the one or more computers to perform operations comprising:
generating, using ground truth data, first training input, wherein the first training input includes training labels;
generating an augmented dataset from multiple data sources as second training input, wherein the augmented dataset is generated using (i) bathymetric data and (ii) simulated data based on satellite data indicating one or more coastal ecosystems; and
training a machine learning model using (i) the first training input and (ii) the second training input, such that the machine learning model is trained to predict biomass growth.
